(19) United States
(12) Patent Application Publication
(10) Pub. No.: US 2013/0060430 A1
(43) Pub. Date: Mar. 7, 2013

(54) DRIVER ASSISTANCE IN OPERATING A ROOF OF A CONVERTIBLE VEHICLE

(71) Applicants: Torsten KANNING, Eltville-Erbach (DE); Justus ILLIUM, Mainz (DE)

(72) Inventors: Torsten KANNING, Eltville-Erbach (DE); Justus ILLIUM, Mainz (DE)

(73) Assignee: GM GLOBAL TECHNOLOGY OPERATIONS LLC, Detroit, MI (US)

(21) Appl. No.: 13/606,095

(22) Filed: Sep. 7, 2012

(30) Foreign Application Priority Data
Sep. 7, 2011 (DE) 10 2011 112 686.8

(51) Int. Cl. G08G 1/0967; G06F 17/00; G01C 21/00

(52) U.S. Cl. 701/49; 701/400; 701/408; 340/905

(57) ABSTRACT

A method and a device are provided for the operating assistance of a driver of a convertible vehicle. The method includes, but is not limited to receiving weather data, for a predeterminable surroundings of a current position xₐ, yₐ of the vehicle and/or for a predeterminable surroundings along a current route from the current position of the vehicle to a destination, and generating a warning, as soon as the following conditions are satisfied: the roof is in the open state, or the roof is in the closed state and the roof is brought into the transition state, and in the forecast period at least one value of the forecast precipitation probability is greater than the limit value n_{G}.

### CROSS-REFERENCE TO RELATED APPLICATION

This application claims priority to German Patent Application No. 10 2011 112 686.8, filed Sep. 7, 2011, which is incorporated herein by reference in its entirety.

### TECHNICAL FIELD

The technical field relates to a method and a device for assisting a driver of a convertible vehicle (shortened from here: convertible) with a roof, which can assume a closed state, an open state and a transition state each. Furthermore, the technical field relates to a convertible with such a device.

### BACKGROUND

As is known, convertible vehicles are vehicles with a roof of fabric or metal that can be folded, rolled in or in particular folded back. Modern convertible roofs can be electromechanically opened and closed, which in some cases is possible even up to a travelling speed of 40 km/h. Such vehicles make is possible for the driver and additional vehicle occupants to directly enjoy fair weather and the surroundings with folded-back roof while driving. In the following, the terms “convertible roof” and “roof” are used synonymously.

It is not too rare an occurrence that, for example a convertible is parked by its driver with open roof and during the parking duration precipitations such as rain or hail occur because of a short-term change in weather not anticipated by the driver, so that a substantial damage is created on the convertible. Furthermore, drives with open convertible roof, for example on a highway, frequently lead into regions with precipitation, which is sometimes noticed by the drivers only when it is too late and since there is not always a possibility of stopping on highways, lead to a refreshing shower of the occupants.

In view of the foregoing, at least one object is to provide a method and a device by which a comfortable weather-dependent anticipatory operation of a convertible roof is possible. In addition, other objects, desirable features and characteristics will become apparent from the subsequent summary and detailed description, and the appended claims, taken in conjunction with the accompanying drawings and this background. Moreover, further features, application possibilities and advantages of the invention are obtained from the following summary and description as well as from the explanation of exemplary embodiments of the invention which are shown in the figures.

### SUMMARY

According to an embodiment a method is provided for the operating assistance of a driver of a convertible vehicle having a roof that can be folded back, folded or rolled in, each of which can assume a closed state, an open state and a transition state. The method comprises receiving weather data for predeterminable surroundings U1 of a current position xa, ya of the vehicle and/or for predeterminable surroundings U2 along a current route from the current position xa, ya of the vehicle to a destination. The received weather data comprise a forecast at least of a precipitation probability N(t) for the respective surroundings U1, U2 for a predeterminable forecast period [t0, t0+Δ] extending from a current time t0 into the future, or this forecast of the time-dependent precipitation probability N(t) is determined in each case on the basis of the received weather data in the vehicle. Secondly, predetermining a limit value NG of a precipitation probability. Thirdly, generating and outputting a warning as soon as the following conditions are satisfied: the roof is in the open state, or the roof is brought from the closed state into the transition state, and in the forecast period [t0, t0+Δ] at least a value N(t) of the forecast precipitation probability N(t) is greater than the limit value NG, wherein the warning should prompt the driver to transfer the window, the sliding roof and the roof into the closed state.

The weather data either already comprises a forecast or forecast data of the precipitation probability N(t) for the respective surroundings U1, U2 (first case), or the weather data comprises meteorological source data from which a forecast of the precipitation probability N(t) for the respective surroundings U1, U2 in the vehicle can be determined (second case). Corresponding precipitation forecast models are known in the prior art. For a forecast period of up to six hours, rain radar data and synoptic station data are preferably used here as staring data in order to extrapolate the rain radar data. For a forecast period of more than six hours, the forecast of the precipitation probability N(t) is determined by means of complex weather models. The corresponding source data is transmitted with the weather data in the second case.

The forecast period preferably comprises the following: approximately 1 hour, approximately 2 hours, approximately 3 hours, approximately 4 hours, approximately 5 hours, approximately 6 hours, approximately 8 hours, approximately 10 hours or approximately 12 hours. Particularly preferably, the forecast period comprises a period between approximately 1 and approximately 4 hours, since here an extrapolation of current rain radar data (which for example widely available in Europe or USA) can be utilized with adequate accuracy.

The surroundings U1 are defined by the current position xa, ya of the vehicle. Preferably, the surroundings U1 are defined by a circle with a radius r, the center point of which forms the current position xa, ya of the vehicle. The radius r preferably lies in a range from approximately 1 km to approximately 100 km and preferably amounts to approximately 5 km, approximately 10, km, approximately 15 km, approximately 20 km, approximately 25 km, approximately 30 km, approximately 40 km, approximately 50 km, approximately 60 km, approximately 70 km, approximately 80 km or approximately 90 km. The radius is either predetermined in a fixed manner or can be freely selected by the driver if preferred. Obviously, the surroundings U1 can also assume any other geometrical shape.

The surroundings too are defined by a current route from the current position xa, ya of the vehicle to a destination. Preferably, the surroundings U2 are obtained as the area swept by a circle with radius r in the surroundings of the route, when the center point of the circle migrates from the current position xa, ya along the current route to the destination. The radius r preferably lies in a range from approximately 1 km to approximately 100 km and preferably amounts to approximately 5 km, approximately 10, km, approximately 15 km, approximately 20 km, approximately 25 km, approximately 30 km, approximately 40 km, approximately 50 km, approximately 60 km, approximately 70 km, approximately 80 km or approximately 90 km. The radius is either predetermined in a fixed manner or can freely selected by the driver if preferred. In particular, the radius r can increase with increasing distance from the current position the direction of the destination. Obviously, the surroundings U2 can also assume any other geometrical shape.

The term of “precipitation probability N(t)” indicates the probability with which the precipitation occurs at the time t. Here, precipitation includes in particular rain, hail, snow, sand or ash. The precipitation probability N(t) can assume values from approximately 0% or approximately 100% or from approximately 0 to approximately 1. If the precipitation probability N(t) in the entire forecast period [t0, t0+Δ] is equal to zero, no precipitation whatsoever is expected. If the precipitation probability N(t) throughout the forecast period [t0, t0+Δ] is equal to 1 or 100%, continuous precipitation must be expected. In the simplest case, the forecast precipitation probability N(t) or the forecast precipitation probability value n(t) refers to the entire surroundings, for example to the entire region U1 or the entire region U2, so that the respective surroundings at a time t are assigned a uniform precipitation probability value N(t). With sufficiently “small” surroundings (for example radius r<approximately 25 km) this is sufficiently accurate while with “large” surroundings (for example radius>approximately 50 km) local differences of the precipitation probability N(t) that occur locally are not depicted, so that the information power and thus user friendliness decreases in this case.

To rectify this disadvantage, the precipitation probability N(t) is preferably transmitted in the weather data as time-dependent precipitation probability field N(x, y, t), or as such, determined in the vehicle on the basis of suitably transmitted metrological source data. In the precipitation probability field N(x, y, t) a forecast precipitation probability value N(x, y, t) is assigned to each location x, y, of the respective surroundings U1, U2 at any time of the forecast period [t0, t0+Δ]. Because of this, far more detailed local evaluations of the weather situation or of the precipitation situation are possible than in the previously described case.

The predetermined limit value nG of the precipitation probability is preferably selected from the range from approximately 40% to approximately 100% and in particular amounts to approximately 50%, approximately 60%, approximately 70%, approximately 80% or approximately 90%. (Respectively: approximately 0.4 to approximately 1.0, in particular approximately 0.5, approximately 0.6, approximately 0.7, approximately 0.8 or approximately 0.9). The limit value can be predetermined in a fixed manner or can be preferably set manually. The limit value can furthermore be selected as a function of a planned parking duration (preferably automatically) in the case of a convertible vehicle that is to be parked with open roof, wherein with shorter parking duration, rather higher values (for example approximately 70-approximately 100%) and with longer parking duration, rather lower values (for example approximately 50-80%) are preferably used as limit value nG. The limit value nG can preferably grow on the current route to the destination with growing distance from the current position.

Generating and outputting of a warning only takes place when the conditions are satisfied, according to which 1, the roof is in the open state, or 2, the roof is brought from the closed state into the transition state, and 3, in the forecast period [t0, t0+Δ] at least one value N(t) of the forecast precipitation probability N(t) is greater than the limit value nG. This means, the warning is generated and output under the conditions 1+3 and 2+3 The inclusion of the condition 2+3 covers for example situations in which the driver following the start-up of the convertible actuates the operating element for an (automatic) opening of the vertical roof without knowledge of the precipitation that is present in the immediate surroundings or in the near surroundings on the selected current route. The warning can initially prevent the opening of the convertible roof so that the driver after this warning either leaves the convertible roof in the closed state or additionally confirms an opening of the roof for example with an additional input. The warning can be output as visual and/or acoustic information. In particular, it can be amended by further information when output on a display.

The method is characterized in that the outputting of the warning takes place only when in the forecast period [t0, t0+Δ], precipitation probability values n(x, y, t) for locations xi, yi of the respective surroundings U1, U2 dependent on the current position xa, ya of the vehicle and/or a driving direction of the vehicle, exceed the limit value nG. Thus it is possible for example to only analyze surrounding regions located ahead in current driving direction with respect to an exceeding of the limit value nG and to output a warning when in these surrounding regions (part regions of the surroundings U1, U2) the limit value nG in the forecast period is exceeded. On the other hand it is possible to use segments of the surroundings assigned to the current position, or segments of the surroundings have an azimuth angle range of approximately 315°-approximately 45° (north range), approximately 45°-approximately 135° (east range), approximately 135°-approximately 225° (south range) and approximately 225° to approximately 315° (west range) as basis for the analysis of an exceeding of the limit value nG. Further application possibilities of this embodiment are at the discretion of the person skilled in the art and can be easily implemented depending on the setting of tasks and application.

The method is characterized in that based on the precipitation probability field N(x, y, t) and the current position xa, ya of the vehicle it is determined whether and if applicable at what time t1 a forecast precipitation probability value N(xa, ya, t) assigned to the current position xa, ya exceeds the limit value nG in the forecast period [t0, t0+Δ], and at which, provided such a time t1 was determined, at least this time is output. If the vehicle for example is parked by the driver with open convertible roof, the driver can decide by means of a warning and the time t1 determined in this regard whether he closes the roof or leaves it open.

A further embodiment of the method is characterized in that the on the basis of the precipitation probability field N(x, y, t), the current route, the current position xa, ya, and dynamic driving data of the vehicle operated on the planned route, a time span calculated from the current time t0 is determined which indicates when the vehicle on the route ahead reaches a location O1 for the first time, whose assigned precipitation probability value n(x, y, t) at the time of the arrival of the vehicle in this location O1, exceeds the limit vale nG and at which, provided such a time span was determined, at least this time span is output. In addition to the warning output in this case, this version additionally supplies the driver with the information regarding the time or the time period (for example in minutes) the convertible will reach a location O1 on the current route, in which the precipitation probability N(x, y, t) exceeds the limit value nG. The driver can then timely plan a stop for example for closing the convertible roof.

A further embodiment of the method is characterized in that based on the precipitation probability fields N(x, y, t), the current position xa, ya and dynamic driving data of the vehicle operated on the current route with ignition switch on, a distance ahead calculated from the current position xa, ya of the vehicle is determined which indicates the driving distance that can still be covered by the vehicle on the route ahead before a location O1 is reached, whose assigned precipitation probability value N(x, y, t) at the time of the arrival of the vehicle in this location O1, exceeds the limit value nG and at which, provided such a distance was determined, at least this distance is output. In addition to the warning output in this case, this version additionally supplies the driver with the information of the driving distance calculated from the current position xa, ya of the vehicle, the convertible will reach a location O1 on the current route, in which the precipitation probability N(x, y, t) exceeds the limit value nG. The driver can thus timely plan a stop for closing the convertible roof.

A location located on the route in front of the location O1 on the current route is determined and output, which allows safe transferring of the open state of the roof into the closed state. To this end, a navigation system of the vehicle or its navigation database is utilized for example. By proposing a safe location (rest stop, parking space, filling station etc.) for closing the roof, the driver is not encouraged to immediately close the roof after the output of a warning and in particular taking into account a dangerous traffic situation (for example parking on the shoulder of a highway).

A further embodiment of the method is characterized in that after a warning has been generated and output, an alternative route from the current position to the destination is determined, for the surroundings of which the associated precipitation probability is below the limit value nG or which at least permits a longer travelling distance with open roof. This design of the method is obviously possible only when locally resolved precipitation probability fields N(x, y, t) are used, and thus a local resolution of the forecast precipitation situation is possible. Thus, a proposal can be generated for example even without active route prompting for a region of surroundings of the vehicle (for example east/or west of the current position) in which the limit value nG is never exceeded in the forecast period.

A further embodiment of the method is characterized in that as weather data for the predetermined surroundings U1 of the current position xa, ya of the vehicle and/or for the predetermined surroundings U2 along the route planned for the vehicle, rain radar data are received, which upon output of the warning are jointly output with the current position xa, ya of the vehicle and/or the planned travelling route to the destination, in the form of a map representation. Thus, in addition to a map representation of the traffic route network and of the current position of the vehicle, the driver is also shown the current rain radar image of the surroundings. Particularly preferably, in addition to current rain radar data, the received weather data also include rain radar data for a seeding period of time, wherein this rain radar data can be output in the form of a time loop comprising this period. In this version, the driver can retrace the precipitation development in the respective surroundings preceding the current time t0 and from this derive a visual extrapolation for example for the coming two hours. This representation serves to provide further awareness of the current weather information based on which the driver following the output of a warning can make an even more detailed decision regarding a closing of the convertible roof that may be required.

In a further embodiment, the warning, in the case that the vehicle is locked and the conditions generate a warning, is output as electronic message for the wireless transmission to a predetermined address, for example a telephone number, email address etc. of the driver. In this case, the warning is preferably not output in the vehicle but for example output as SMS, email etc. on a smartphone, a computer, a laptop, an I-pad of the driver. It can be provided that following the receipt of such a warning on the receiving device the driver sends a wireless signal for example to the vehicle which causes the vehicle to close the roof.

In a further embodiment, the roof is brought into the closed state in an automated manner, when the conditions are present, but the vehicle state is identical with a predeterminable vehicle state and a warning was generated. In principle, the predeterminable vehicle state can be defined as desired. For example, the predetermined vehicle state is characterized by the following features: the vehicle is parked with open convertible roof, while the vehicle is locked. If in this state a warning is generated, the convertible roof is closed in an automated manner. If on the vehicle a rain sensor is additionally present, the automatic closing of the convertible roof can be additionally started also when the rain sensor senses rain. With this embodiment, water damage to the vehicle interior in the case of a vehicle initially parked with open convertible roof can be effectively prevented, since both forecasts (make possible a timely closing of the roof before rain falls) as well as current local information of precipitation events (although rain can enter the interior of the vehicle in small quantities since the rain sensor responds only after a certain amount of rain) are considered.

According to an embodiment, a device is provided for the operating assistance of a driver of a convertible vehicle with a roof that can assume a closed state, an open state and a transition state. The device according to the invention comprises: a receiver for receiving weather data for a predeterminable surroundings of the vehicle, a position determining device for determining a current vehicle position, a navigation device for navigating in a predetermined traffic route network, in particular for determining a route from the current position to a target position, a means for determining a forecast of at least one time-dependent precipitation probability N(t) for the surroundings for a forecast period extending from a current time into the future, from the weather data, a controller, which is embodied and equipped in order to output a warning to the driver when the conditions are satisfied, according to which the roof is in the open state, or the roof is in the closed state and the roof is brought into the transition state and in the forecast period at least one value n(t) of the forecast precipitation probability N(t) is greater than the limit value nG.

Advantageous further embodiments of the device are obtained from the analogous transfer and application of advantageous features of the previously described method. To this end, reference is also made to the above explanations. Furthermore, the embodiments relate to a convertible vehicle having a device mentioned above.

### BRIEF DESCRIPTION OF THE DRAWINGS

The present invention will hereinafter be described in conjunction with the following drawing figures, wherein like numerals denote like elements, and:

FIG. 1 is a schematic representation of the surroundings U1 and U2;

FIG. 2 is a graphic for representing a precipitation probability N(t) over the time t;

FIG. 3 is a schematic method sequence of a method; and

FIG. 4 is a schematic construction of a device.

### DETAILED DESCRIPTION

The following detailed description is merely exemplary in nature and is not intended to limit application and uses. Furthermore, there is no intention to be bound by any theory presented in the preceding background or summary or the following detailed description.

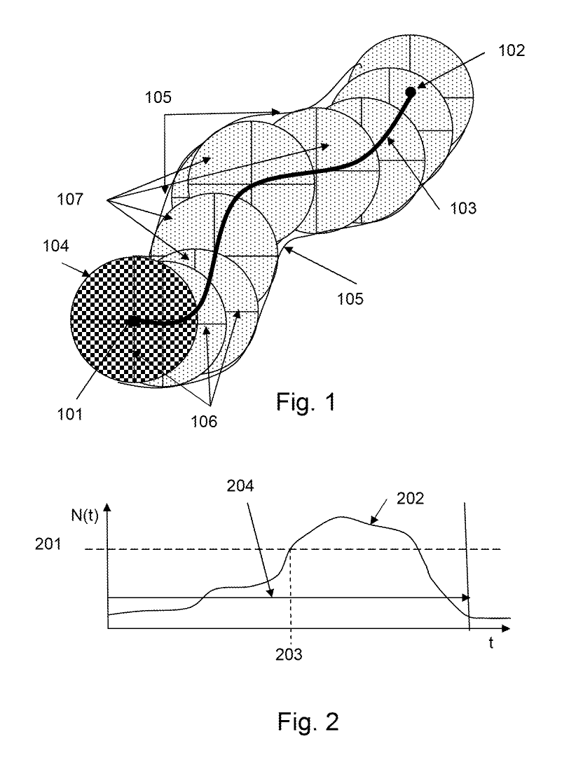

FIG. 1 shows a schematic representation to explain a possible construction of the surroundings U1 and U2. Shown is a schematic current route 103 of a road traffic network, which connects the current position 101 of the convertible to a destination 102. The surroundings U1 in this case are defined by the current position 101 and a radius 106, which sweeps a circular area with the radius 106 about the current position 101. The surroundings U1 are thus defined independently of a current route 103 and are thus in particular also independent of whether an active route navigation is currently activated or not. The surroundings U2 in this case are obtained as the area that is swept by a circle 107 with the radius 106 when the latter migrates along the current route 103 from the current position 101 to the destination 102. To this end, the circle 107 is shown in FIG. 1 for different positions along the current route 103. Preferably, during the construction of the surroundings U2, the radius 106 of the circle 107 during its migration from the current position 101 to the destination 102 becomes the larger, the closer it comes to the destination 102. For example, the radius 106 of the circle can grow linearly with progressing approach of the destination 102 from r to 2*r at the destination 102. This has the advantage that for the positions that are located further away from the current position of the vehicle, weather data for the precipitation forecast of a larger region are utilized on the current route and thus the quality of the precipitation forecast can thus be largely maintained independently of the driving time.

FIG. 2 shows a graphic for representing a precipitation probability N(t) over the time t. It is assumed that for the surroundings U1 from the FIG. 1, a precipitation probability value N(t) uniformly describing the entire surroundings U1 is determined from received weather data for a forecast period 204, which in the forecast period 204 has the profile 202 shown in FIG. 2. It is assumed, furthermore, that a limit value nG 201 of the precipitation probability N(t) is predetermined, which in this case is selected for example at approximately 75% precipitation probability. As is evident from FIG. 2, the forecast precipitation probability value N(t) exceeds the limit value nG for the first time in the forecast period at the time 203. Thus, a condition for the triggering of a warning is satisfied.

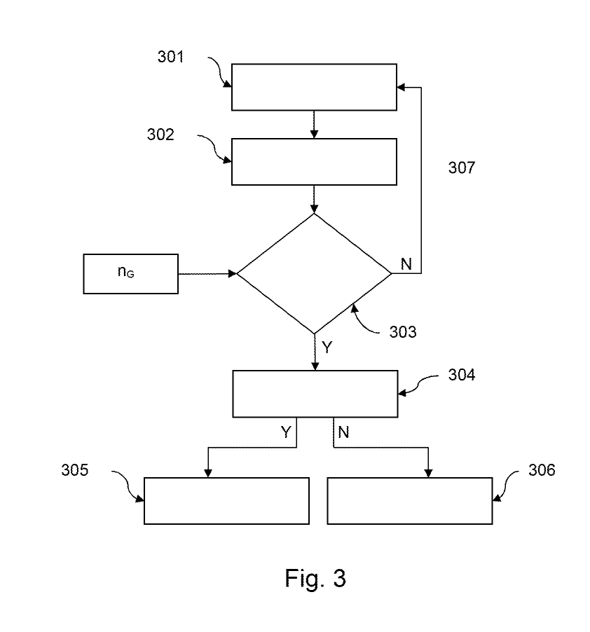

FIG. 3 shows a schematic method sequence of a method according to the invention for the operating assistance of a driver of a convertible vehicle with a roof that can be folded back, folded or rolled in, which in each case can assume a closed state, an open state and a transition state. In a first step 301, weather data are received by wireless method, which relate to predeterminable surroundings U1 of a current position xa, ya of the vehicle. In a second step 302, a forecast at least of a precipitation probability N(t) for the surroundings U1 is determined from the received weather data for a forecast period [t0, t0+Δ] extending from a current time t0 into the future. In a third step 303 it is checked if in the forecast period [t0, t0+Δ] at least one value N(t) of the forecast precipitation probability N(t) is greater than a predetermined limit value nG and furthermore, if the roof is in the open state.

If this is not the case, the method re-commences with step 301 (indicated by the arrow 307). However, if this is the case, a warning is generated and it is checked if the vehicle is locked in a fourth step 304. If this is the case (Y), the warning as SMS warning is sent to a predetermined mobile radio number in step 305. If this is not the case (N), the warning is output in the vehicle as visual and acoustic signal. The warning is to prompt the driver to transfer the roof into the closed state.

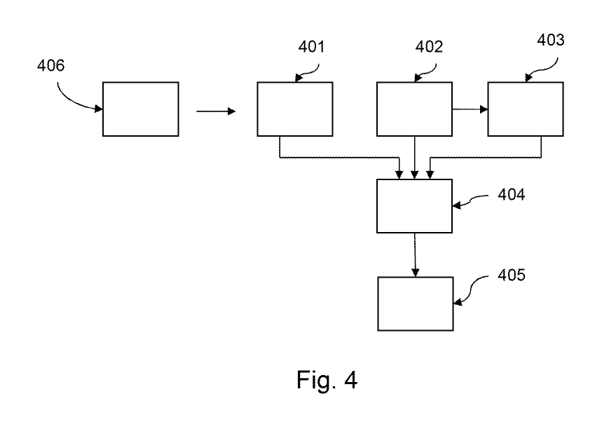

FIG. 4 shows a schematic construction of a device for the operating assistance of a driver of a convertible vehicle with a roof that can assume a closed state, an open state and a transition state. The device comprises a receive 401 for receiving weather data for a predeterminable surroundings of the vehicle, which are broadcast by a transmitter 406, a position determining means 402 for determining a current vehicle position, a navigation means 403 for navigating in a predetermined traffic route network, in particular for determining a route from the current position to a target position, a determination device 404 for determining a forecast of at least a time-dependent precipitation probability N(t) for the surroundings for a forecast period extending from a current time into the future from the weather data, and a controller 405, which is embodied and equipped in order to output a warning to the driver when the following conditions are satisfied: the roof is in the open state, and in the forecast period at least one value n(t) of the forecast precipitation probability N(t) is greater than the limit value nG.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for providing operating assistance of a driver of a vehicle with a roof that can assume a closed state, an open state, and a transition state, comprising:
receiving weather data for a predeterminable surroundings of a current position xₐ, yₐ of the vehicle, the weather data comprises a forecast of at least one precipitation probability for the predeterminable surroundings for a predeterminable forecast period [t₀, t₀+Δ] extending from a current time t₀ into a future;
determining a limit value n_{G} of a precipitation probability; and
generating a warning upon satisfaction of at least one of a plurality of conditions, the plurality of conditions comprising:
is in the open state;
the roof is in the closed state and the roof is brought into the transition state; and
in a forecast period [t₀, t₀+Δ], at least one value of a forecast precipitation probability is greater than the limit value n_{G},
wherein the warning comprises prompt of the driver to transfer the roof into the closed state.

2. The method according to claim 1, wherein the precipitation probability is present as time-dependent precipitation probability field N(x, y, t), which assigns values N (x, y, t) of the forecast precipitation probability to each location x, y, of surroundings.

3. The method according to claim 2, wherein the outputting of the warning takes place when in the forecast period [t₀, t₀+Δ] the values n(x, y, t) for locations xᵢ, yᵢ of the respective surroundings dependent on the current position xₐ, yₐ of the vehicle.

4. The method according to claim 2, wherein based on the precipitation probability field N(x, y, t) and the current position xₐ, yₐ of the vehicle it is determined if and if applicable at a time t₁ a forecast precipitation probability value N(xₐ, yₐ, t) assigned to the current position xₐ, yₐ exceeds the limit value n_{G} in the forecast period [t₀, t₀+Δ], and at which, provided the time t₁ was determined, at least the time t₁ is output.

5. The method according to claim 2, wherein based on the precipitation probability field N(x, y, t), a current route, the current position xₐ, yₐ, and dynamic driving data of the vehicle operated on the current route, a time span calculated from the current time t₀ is determined which indicates when the vehicle on the current route reaches a location O₁ for a first time, whose value n(x, y, t) at a time of arrival of the vehicle at the location O₁, exceeds the limit value n_{G}, and at which, provided the time span was determined, at least the time span is output.

6. The method according to claim 2, wherein based on precipitation probability fields N(x, y, t), a current route, the current position xₐ, yₐ and dynamic driving data of the vehicle operated on the current route a distance ahead, calculated from the current position xₐ, yₐ of the vehicle is determined which indicates a driving distance that can still be covered by the vehicle on the current route before a location O₁ is reached, whose assigned precipitation probability value N(x, y, t) at a time of arrival of the vehicle at the location O₁, exceeds the limit value n_{G}, and at which, provided such a distance was determined, at least the distance is output.

7. The method according to claim 5, wherein on the current route, a location located before the location O₁ is determined and output which allows a safe transferring of the open state of the roof into the closed state.

8. The method according to claim 1, wherein after a warning was generated and output, an alternative route from the current position xₐ, yₐ to a destination is determined, for surroundings of which the precipitation probability is below the limit value n_{G}.

9. The method according to claim 1, wherein as weather data for predetermined surroundings of the current position xₐ, yₐ of the vehicle, rain radar data is received, which upon outputting the warning are jointly output with the current position xₐ, yₐ of the vehicle in form of a map representation.

10. The method according to claim 9, wherein the rain radar data in addition to current rain radar data also include rain radar data for a preceding period of time and the rain radar data are output in the form of a time loop including this period of time.

11. The method according to claim 1, wherein if the vehicle is locked and a warning is generated, the warning is output as electronic message for a wireless transmission to a mobile receiving device, for example a smartphone of the driver.

12. The method according to claim 1, wherein the roof is brought into the closed state in an automated manner, when the state is substantially identical to a predeterminable vehicle state and a warning was generated.

13. A device for providing operating assistance of a driver of a vehicle with a roof that can assume a closed state, an open state and a transition state, comprising:
a receiver that is configured to receive weather data for a predeterminable surroundings of the vehicle;
a position determining device that is configured to determining a current vehicle position xₐ, yₐ;
a navigation device that is configured to navigate in a predetermined traffic route for determining a route from a current position to a destination,
a forecast determining device that is configured to forecast of at least one time-dependent precipitation probability for surroundings for a forecast period extending from a current time into a future from the weather data; and
a controller that is configured to generate a warning to the driver when the following at least one of a plurality of conditions is satisfied, the plurality of conditions comprising:
the roof is in the open state, and
in the forecast period, at least one value of a forecast precipitation probability is greater than a limit value n_{G}.
